(19) United States
(12) Patent Application Publication
(10) Pub. No.: US 2026/0081710 A1
(43) Pub. Date: Mar. 19, 2026

(54) BLUETOOTH COMMUNICATION METHOD, AND DEVICE

(71) Applicant: Realme Mobile Telecommunications (Shenzhen) Co., Ltd., Shenzhen (CN)

(72) Inventor: Heng SU, Shenzhen (CN)

(21) Appl. No.: 19/402,300

(22) Filed: Nov. 26, 2025

Related U.S. Application Data
(63) Continuation of application No. PCT/CN2024/087002, filed on Apr. 10, 2024.

(30) Foreign Application Priority Data
May 29, 2023 (CN) 202310622705.6

(51) Int. Cl. H04L 1/00; H04L 27/10; H04L 27/18; H04W 8/22; H04W 72/20; H04W 76/10

(52) U.S. Cl. CPC H04L 1/0003; H04L 1/0017; H04L 27/10; H04L 27/18; H04W 8/22; H04W 72/20; H04W 76/10; H04L 2203/02

(57) ABSTRACT

The present application relates to a Bluetooth communication method and a device. The method may be performed by a first device. The first device may establish Bluetooth connection with a second device. The method may include: performing link communication with the second device according to a first modulation mode; in a case where it is detected that the quality of link communication is less than a preset threshold, adjusting the modulation mode of the first device from the first modulation mode to a second modulation mode, and performing the link communication with the second device according to the second modulation mode. The anti-interference capability of the second modulation mode is greater than that of the first modulation mode.

### CROSS REFERENCE TO RELATED APPLICATIONS

The present application is a continuation of International Patent Application No. PCT/CN2024/087002, filed Apr. 10, 2024, which claims priority to Chinese Patent Application No. 202310622705.6, filed May 29, 2023, the entire disclosures of which are incorporated herein by reference.

### TECHNICAL FIELD

The present disclosure relates to the field of wireless communication technologies, and in particular, to a Bluetooth communication method, and a device.

### BACKGROUND

In recent years, Bluetooth technology has become one of the main communication approaches in the field of wireless communication. Different devices may realize convenient, fast, flexible, secure, low-cost, and low-power voice and data communication through the Bluetooth technology. These different devices may be various types of devices such as mobile phones, vehicle-mounted devices, headsets, music players or the like.

The application scenarios of the Bluetooth technology are becoming more and more numerous and complex. In daily applications, for two electronic devices with an established Bluetooth connection therebetween, a communication link between the two electronic devices may be easily affected by factors such as distance, external interference etc., which may reduce communication efficiency and also affect quality of Bluetooth scenarios such as listening to music, making phone calls or the like.

### SUMMARY OF THE DISCLOSURE

According to a first aspect of the present disclosure, a Bluetooth communication method may be provided. The method may be performed by a first device. A Bluetooth connection may be established between the first device and a second device. The method may include: performing, according to a first modulation mode, link communication with the second device; and, in a case where it is detected that a quality of the link communication is less than a preset threshold, adjusting a modulation mode of the first device from the first modulation mode to a second modulation mode, and performing the link communication with the second device according to the second modulation mode. An anti-interference capability of the second modulation mode may be greater than that of the first modulation mode.

According to a second aspect of the present disclosure, a Bluetooth communication method may be provided. The method may be performed by a second device. A Bluetooth connection may be established between the second device and a first device. The method may include: performing, according to a first modulation mode, link communication with the first device; receiving a first control message sent by the first device, adjusting a modulation mode of the second device from the first modulation mode to a second modulation mode, the second modulation mode being indicated by the first control message, and performing the link communication with the first device according to the second modulation mode. The second modulation mode may be a modulation mode determined by the first device in a case where it is detected that a quality of the link communication is less than a preset threshold. An anti-interference capability of the second modulation mode may be greater than that of the first modulation mode.

According to a third aspect of the present disclosure, an electronic device may be provided. The electronic device may include a processor and a memory. The memory may be configured to store a computer program. The processor may be configured to call and run the computer program stored in the memory to execute a Bluetooth communication method. A Bluetooth connection may be established between the electronic device and a second device. The method may include: performing, according to a first modulation mode, link communication with the second device; and in a case where it is detected that a quality of the link communication is less than a preset threshold, adjusting a modulation mode of the electronic device from the first modulation mode to a second modulation mode, and performing the link communication with the second device according to the second modulation mode. An anti-interference capability of the second modulation mode may be greater than that of the first modulation mode.

### BRIEF DESCRIPTION OF THE DRAWINGS

FIG. 1 is a schematic diagram of a composition structure of a Bluetooth communication system.

FIG. 2 is a schematic diagram of a communication process in a Bluetooth protocol specification.

FIG. 3 is a schematic flowchart of a Bluetooth communication method according to an embodiment of the present disclosure.

FIG. 4 is a schematic diagram of curves between signal-to-noise ratio and bit error rate under different modulation modes according to an embodiment of the present disclosure.

FIG. 5 is a schematic flowchart of another Bluetooth communication method according to an embodiment of the present disclosure.

FIG. 6 is a schematic flowchart of yet another Bluetooth communication method according to an embodiment of the present disclosure.

FIG. 7 is a schematic flowchart of still another Bluetooth communication method according to an embodiment of the present disclosure.

FIG. 8 is a schematic diagram of a composition structure of a Bluetooth communication apparatus according to an embodiment of the present disclosure.

FIG. 9 is a schematic diagram of the composition structure of another Bluetooth communication apparatus according to an embodiment of the present disclosure.

FIG. 10 is a schematic diagram of a composition structure of an electronic device according to an embodiment of the present disclosure.

FIG. 11 is a schematic diagram of a composition structure of a chip according to an embodiment of the present disclosure.

### DETAILED DESCRIPTION

According to a first aspect of the present disclosure, a Bluetooth communication method may be provided. The method may be performed by a first device. A Bluetooth connection may be established between the first device and a second device. The method may include: performing, according to a first modulation mode, link communication with the second device; and in a case where it is detected that a quality of the link communication is less than a preset threshold, adjusting a modulation mode of the first device from the first modulation mode to a second modulation mode, and performing the link communication with the second device according to the second modulation mode. An anti-interference capability of the second modulation mode may be greater than that of the first modulation mode.

In some embodiments, in a case where it is detected that the quality of the link communication is less than the preset threshold, the method may further include: sending a first control message to the second device. The first control message may be configured to instruct the second device to adjust its own modulation mode to the second modulation mode.

In some embodiments, the operation of adjusting the modulation mode of the first device from the first modulation mode to the second modulation mode may include: adjusting the modulation mode of the first device from the first modulation mode to the second modulation mode through a link layer of the first device.

In some embodiments, the operation of detecting that the quality of the link communication is less than the preset threshold may include: determining the number of consecutive retransmissions of data sent by the first device; and in a case where the number of consecutive retransmissions is greater than a first threshold, determining that the quality of the link communication is less than the preset threshold.

In some embodiments, the operation of detecting that the quality of the link communication is less than the preset threshold may include: determining a packet error rate of data sent by the first device; in a case where the packet error rate is greater than a second threshold, determining that the quality of the link communication is less than the preset threshold.

In some embodiments, the operation of detecting that the quality of the link communication is less than the preset threshold may include: determining received signal strength indicator message for data received by the first device; in a case where the received signal strength indicator message is less than a third threshold, determining that the quality of the link communication is less than the preset threshold.

In some embodiments, the operation of detecting that the quality of the link communication is less than the preset threshold may include: determining a bit error rate of data sent by the first device; and in a case where the bit error rate is greater than a fourth threshold, determining that the quality of the link communication is less than the preset threshold.

In some embodiments, modulation modes supported by the Bluetooth connection may include: Gaussian frequency shift keying (GFSK) modulation mode, π/4-differential quadrature phase shift keying (π/4-DQPSK) modulation mode, and 8-differential phase shift keying (8DPSK) modulation mode. The anti-interference capability of the 8DPSK modulation mode may be less than that of the GFSK modulation mode. The anti-interference capability of the GFSK modulation mode may be less than that of the π/4-DQPSK modulation mode.

In some embodiments, the first modulation mode may be the 8DPSK modulation mode. The second modulation mode may be the π/4-DQPSK modulation mode.

In some embodiments, different modulation modes may match with different transmission rates. The method may further include: while performing, according to the first modulation mode, the link communication with the second device, determining that a transmission rate of data sent by the first device is a first rate; in a case where it is detected that the quality of the link communication is less than the preset threshold, adjusting the modulation mode of the first device from the first modulation mode to the second modulation mode, and determining that the transmission rate of data sent by the first device is adjusted from the first rate to a second rate.

In some embodiments, after performing, according to the second modulation mode, the link communication with the second device, the method may further include: in a case where it is detected that the quality of the link communication is greater than the preset threshold, adjusting the modulation mode of the first device from the second modulation mode to a third modulation mode, and continuing the link communication with the second device according to the third modulation mode. The anti-interference capability of the third modulation mode may be less than that of the second modulation mode.

In some embodiments, in a case where it is detected that the quality of the link communication is greater than the preset threshold, the method may further include: sending a second control message to the second device. The second control message may be configured to instruct the second device to adjust its own modulation mode to the third modulation mode.

According to a second aspect of the present disclosure, a Bluetooth communication method may be provided. The method may be performed by the second device. A Bluetooth connection may be established between the second device and the first device. The method may include: performing, according to the first modulation mode, link communication with the first device; receiving the first control message sent by the first device, adjusting the modulation mode of the second device from the first modulation mode to the second modulation mode, the second modulation mode being indicated by the first control message, and performing the link communication with the first device according to the second modulation mode. The second modulation mode may be the modulation mode determined by the first device in a case where it is detected that the quality of the link communication is less than the preset threshold. The anti-interference capability of the second modulation mode may be greater than that of the first modulation mode.

In some embodiments, the first modulation mode may be the 8DPSK modulation mode. The second modulation mode may be the π/4-DQPSK modulation mode.

In some embodiments, after performing the link communication with the first device according to the second modulation mode, the method may further include: receiving the second control message sent by the first device, adjusting the modulation mode of the second device from the second modulation mode to the third modulation mode, the third modulation mode being indicated by the second control message, and performing the link communication with the first device according to the third modulation mode. The third modulation mode may be the modulation mode determined by the first device in a case where it is detected that the quality of the link communication is greater than the preset threshold. The anti-interference capability of the third modulation mode may be less than that of the second modulation mode.

According to a third aspect of the present disclosure, a Bluetooth communication apparatus may be provided. The Bluetooth communication apparatus may be applied to the first device. The apparatus may include a first communication unit and a first adjusting unit. The first communication unit may be configured to perform the link communication with the second device according to the first modulation mode. The first adjusting unit may be configured to: in a case where it is detected that the quality of the link communication is less than the preset threshold, adjust the modulation mode of the first device from the first modulation mode to the second modulation mode. The first communication unit may be further configured to: perform the link communication with the second device according to the second modulation mode. The anti-interference capability of the second modulation mode may be greater than that of the first modulation mode.

In some embodiments, the first communication unit may be further configured to: send the first control message to the second device. The first control message may be configured to instruct the second device to adjust its own modulation mode to the second modulation mode.

According to a fourth aspect of the present disclosure, a Bluetooth communication apparatus may be provided. The apparatus may be applied to the second device. The apparatus may include a second communication unit and a second adjusting unit. The second communication unit may be configured to perform, according to the first modulation mode, the link communication with the first device; and, the second communication unit may be further configured to receive the first control message sent by the first device. The second adjusting unit may be configured to adjust the modulation mode of the second device from the first modulation mode to the second modulation mode. The second modulation mode may be indicated by the first control message. The second communication unit may be further configured to: perform the link communication with the first device according to the second modulation mode. The second modulation mode may be the modulation mode determined by the first device in a case where it is detected that the quality of the link communication is less than the preset threshold. The anti-interference capability of the second modulation mode may be greater than that of the first modulation mode.

According to a fifth aspect of the present disclosure, an electronic device may be provided. The electronic device may include a processor and a memory. The memory may be configured to store a computer program. The processor may be configured to call and run the computer program stored in the memory to execute the method as described in the first or second aspect.

According to a sixth aspect of the present disclosure, a chip including the processor may be provided. The processor may be configured to call and run the computer program from the memory, to enable a device installed with the chip to executes the method as claimed in the first or second aspect.

According to a seventh aspect of the present disclosure, a computer-readable storage medium may be provided. The computer-readable storage medium may store the computer program. When the computer program is executed by at least one processor, the method as described in the first or second aspect may be implemented.

According to an eighth aspect of the present disclosure, a computer program product including the computer program or an instruction may be provided. When the computer program or the instruction is executed by at least one processor, the method as described in the first or second aspect may be implemented.

In order to understand features and technical content of the embodiments of the present disclosure in greater detail, an implementation of the embodiments of the present disclosure may be described in detail below with reference to the accompanying drawings. The accompanying drawings may be only for reference and illustration purposes, and may not be intended to limit the embodiments of the present disclosure.

Unless otherwise defined, all technical and scientific terms adopted herein may have the same meanings as commonly understood by those skilled in the technical field of the present disclosure. The terms adopted herein may be only for the purpose of describing the embodiments of the present disclosure, and may be not intended to limit the present disclosure.

In the following description, references to “some embodiments” may describe a subset of all possible embodiments. However, that “some embodiments” may be the same subset or different subsets of all possible embodiments, and may be combined with each other without conflict.

The terms “first\second\third” involved in the embodiments of the present disclosure may be only used to distinguish similar objects, and may not represent a specific order of these objects. The “first\second\third” may be interchanged in specific order or sequence where permitted, so that the embodiments of the present disclosure described herein may be implemented in an order other than that illustrated or described herein.

With rapid development of communication technologies, the Bluetooth has become a common data transmission approach between electronic devices, enabling short-range wireless data transmission between electronic devices. The electronic devices may for example be portable devices such as smart phones, tablet computers, laptop computers, palmtop computers, wireless headsets, smart speakers, smart watches or the like. With evolution of the Bluetooth technology, from an initial realization of short-range communication to the current communication requirements for the Internet of Everything, transmission structures of Bluetooth data frames also constantly evolve. The application scenarios of the embodiments of the present disclosure are the Bluetooth data transmission between electronic devices. In an application scenario, a Bluetooth connection is established between a smart sports bracelet and a smartphone, which may quickly transmit, through a Bluetooth channel, information collected during sports such as running, swimming, cycling or the like to terminal devices such as smartphones or the like, allowing users to better monitor sports conditions in real time. In another application scenario, the Bluetooth connection may be established between the smart sports bracelet, the smartphone, and a smart watch. The smart watch, as a central hub, may receive sports information collected from the smart sports bracelet through the Bluetooth channel. The smart watch may also act as a display device to receive emails, short messages or the like, from the smartphone through the Bluetooth channel.

For example, FIG. 1 is a schematic diagram of a composition structure of a Bluetooth communication system 100. As illustrated in FIG. 1, the Bluetooth communication system 100 may include a first device 110 and a second device 120. The first device 110 may provide communication coverage for a specific geographical area based on Bluetooth, and may communicate with the second device 120 located within the corresponding coverage area.

FIG. 1 exemplarily illustrates two electronic devices. In some embodiments, the Bluetooth communication system 100 may include a plurality of electronic devices. The coverage area of each electronic device may include other numbers of electronic devices, which is not specifically restricted in the embodiments of the present disclosure.

The electronic devices in the embodiments of the present disclosure may also be referred to as Bluetooth devices, terminal devices, user equipment (UE), access terminals, subscriber units, subscriber stations, mobile stations, mobile terminals, remote stations, remote terminals, mobile devices, user terminals, terminals, wireless communication devices, user agents, or user apparatuses or the like. The electronic device may be a station in a wireless local area network (WLAN), a cellular phone, a cordless phone, a session initiation protocol (SIP) phone, a wireless local loop (WLL) station, a personal digital assistant (PDA) device, a handheld device with wireless communication function, a computing device, or other processing devices connected to a wireless modem, a vehicle-mounted device, a wearable device, and a next-generation communication system.

By way of example and not limitation, in the embodiments of the present disclosure, the electronic device may also be a wearable device. The wearable device may also be called a wearable smart device, which may be a general term for devices that apply wearable technologies to intelligently design daily wear and is thus developed to be wearable. The wearable device may include such as glasses, gloves, watches, clothing, shoes or the like. The wearable device may be a portable device that is directly worn on the user body or integrated into clothes or accessories of the user. The wearable device may not only be a hardware device, but may also realize powerful functions through software support, data interaction, and cloud interaction. In a broad sense, the wearable smart device may include: those with full functions, large size, and capable of realizing complete or partial functions without relying on smartphones, such as the smart watch or the smart glasses; as well as those that focus only on a certain type of application function and need to be used with other devices such as smartphones, for example, various smart bracelets and smart jewelry for physical sign monitoring.

In some embodiments, for the Bluetooth communication system 100, the first device 110 may be a transmitting device, the second device 120 may be a receiving device. In some embodiments, the first device 110 may be the receiving device, and the second device 120 may be the transmitting device.

In some other embodiments, for the Bluetooth communication system 100, the first device 110 may be a master device, and the second device 120 may be a slave device. In some other embodiments, the first device 110 may be the slave device, and the second device 120 may be the master device.

For example, an architecture of the Bluetooth communication system 100 may include three parts: a bottom-layer hardware module, an intermediate protocol layer, and an application layer. The Bluetooth bottom-layer hardware module may be composed of a base band (BB) layer, a link manager (LM) layer, and a radio frequency (RF) layer. The RF layer may be mainly responsible for RF processing and base band modulation. The base band layer may be responsible for frequency hopping, and transmission of the Bluetooth data and message frames. The link management layer may be responsible for connection establishment, disconnection, and link security and control. There are two types of links: a synchronous connection oriented (SCO) link and an asynchronous connectionless link (ACL) link. The SCO link may be mainly configured for a synchronous voice transmission, and the ACL link may be mainly configured for a packet data transmission. An SCO connection is a symmetric connection, which may use reserved time slots to transmit data packets. After the SCO connection is established, the master device and the slave device may send the SCO data packets without being selected. The SCO data packets may transmit both voice and data, but when transmitting the data, the SCO data packets may only be used to retransmit damaged part of the data. The ACL link may transmit the data packets in a directional manner, and may support both symmetric connections and asymmetric connections. That is, the ACL link may support both one-to-one and one-to-many. The master device may be responsible for controlling a link bandwidth and determining how much bandwidth each slave device in a piconet may occupy and the symmetry of the connection. The slave device may only transmit data when being selected. The ACL link may also support receiving broadcast messages sent by the master device to all slave devices in the piconet. Both the intermediate protocol layer and the application layer may be software modules. An upper-layer software module may not be capable of direct connection with the bottom-layer hardware module. Messages and data between the interfaces of the upper-layer software module and the bottom-layer hardware module may only be able to be transmitted after being interpreted by a host controller interface (HCI). In fact, HCI may be equivalent to a bridge between software and hardware in Bluetooth protocol. The HCI may provide a unified command interface for calling hardware such as the lower-layer base band layer, the link management layer, a status and control register. The Bluetooth intermediate protocol layer may complete functions such as decomposition and reorganization of data frames, control for service quality, group extraction or the like. The Bluetooth intermediate protocol layer may provide services for upper-layer applications, and provide an interface with the bottom-layer hardware module. The intermediate protocol layer may include logical link control and adaptation protocol (L2CAP), service discovery protocol (SDP), radio frequency communication (RFCOMM), object exchange (OBEX), wireless application protocol (WAP), telephony control protocol specification (TCS) or the like. An AT command set may be a protocol stack configured to control mobile phones or modems and transmit other service data. The top-most layer may be the application layer, matching with various application models and application programs.

The following describes protocols in a Bluetooth protocol stack involved in the embodiments of the present disclosure.

The link manager protocol (LMP) may be a data link layer protocol in the Bluetooth protocol stack, responsible for establishing connections between devices. LMP may perform identity authentication and encryption through connection initiation, exchange, and verification, and may determine a baseband data packet size through negotiation. The LMP may perform link setup, authentication, link configuration, etc. The link manager may discover other remote link managers and communicates with them through the LMP.

The base band protocol may be located above a Bluetooth RF layer in the Bluetooth protocol stack, and may together with the RF layer constitute a physical layer of Bluetooth. The baseband and link control layers may ensure physical connections between electronic devices. The baseband protocol may use inquiry and page processes to synchronize transmission frequencies and clock between different devices, and may provide two physical connection modes, namely connection-oriented (SCO) and connectionless (ACL), for baseband data packets. Moreover, a plurality of data transmissions may be implemented on the same RF. The ACL may be suitable for data packets, and the SCO may be suitable for voice and combinations of voice and data. The above-mentioned voice and data packets may all undergo forward error correction or cyclic redundancy check, and may be encrypted. In addition, a special channel may be allocated for various data types (including connection management message and control message). The baseband protocol may be able to transmit voice between electronic devices through various user modes. Connection-oriented voice packets may only need to be transmitted through the baseband and do not reach the L2CAP.

The L2CAP may be an adaptation protocol that shields the baseband protocol from upper-layer protocols. It may be located above the baseband protocol and may belong to the data link layer. It may provide connection-oriented and connectionless data services for the upper layers, and may complete functions such as protocol multiplexing, segmentation and reassembly, service quality transmission, group abstraction or the like. Although the baseband protocol provides two connection types including the SCO and the ACL, the L2CAP may only support the ACL.

Bluetooth may be an open technical specification for short-range wireless communication, which may realize short-range wireless voice and data communication. In the Bluetooth 5.0 specification, Bluetooth may support three rates, for example, three physical rates such as 1 Mbps, 2 Mbps, and 3 Mbps. In practical applications, the electronic device may switch the transmission rate when the network status changes. Specifically, if the network status (i.e., the link quality) changes during the data transmission between the master device and the slave device, the master device and the slave device may negotiate to determine a new transmission rate to be used, and switch the transmission rate to the new transmission rate.

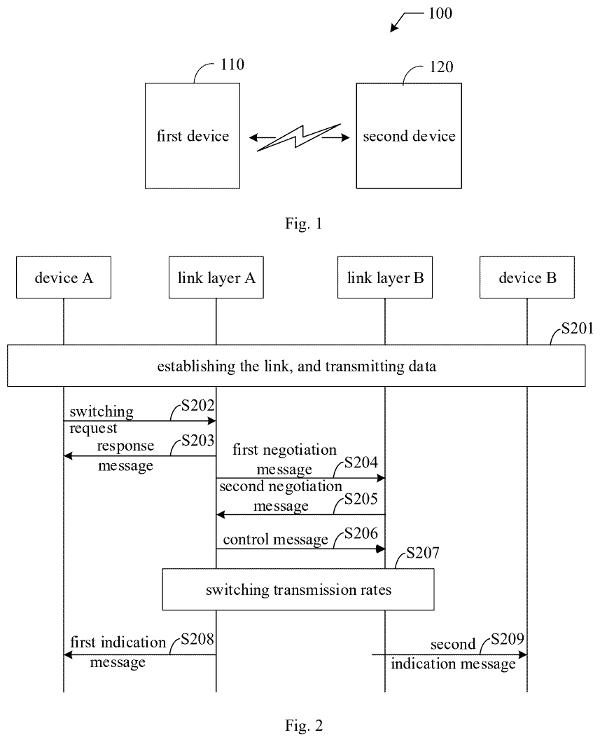

In the embodiments of the present disclosure, FIG. 2 is a schematic diagram of a communication process in the Bluetooth protocol specification. As illustrated in FIG. 2, the process may include the following operations.

The operation at block S201: establishing a link, and transmitting data.

Device A may be the host of the master device, and device B may be the host of the slave device. The Link Layer A may be the link layer of the master device, and the link layer B may be the link layer of the slave device. The master device and the slave device may establish a link connection and transmit data. The link may be an ACL link or an SCO link.

The operation at block S202: sending, by the device A, a transmission rate switching request to a link layer A.

In some embodiments, a host controller of the master device may send the transmission rate switching request to link layer A. The link layer A may be implemented by the upper-layer software module of the master device. Specifically, Device A sends an LE Set PHY HCI command to link layer A, requesting link layer A to switch the transmission rate.

The operation at block S203: sending, by the link layer A, a response message to the device A.

The above-mentioned response message may be feedback message generated by link layer A for the received transmission rate switching request. The response message may be command status message sent for the transmission rate switching request, i.e., the message may be Command Status.

The operation at block S204: sending, by the link layer A, a first negotiation message to a link layer B.

The above-mentioned first negotiation message may be a type of control message, which may indicate the transmission rate preferentially used by the master device and the transmission rate preferentially used by the slave device, both transmission rates may be determined by the master device. Specifically, the first negotiation message may be LL_PHY_REQ.

The operation at block S205: sending, by the link layer B, second negotiation message to the link layer A.

The above-mentioned second negotiation message may be also a type of control message. The second negotiation message may be configured to indicate the transmission rate preferentially used by the master device and the transmission rate preferentially used by the slave device, both of which may be determined by the slave device. Specifically, the second negotiation message may be the LL_PHY_RSP. The format of control data in the protocol data units (PDUs) for the first negotiation message and the second negotiation message may be the same.

The operation at block S206: sending, by the link layer A, the control message to the link layer B.

The above-mentioned control message may instruct the slave device to switch the transmission rate. Specifically, the control message may indicate the transmission rate to be used by the master device and the transmission rate to be used by the slave device.

The operation at block S207: switching, by the link layer A and the link layer B, their respective transmission rates.

The above-mentioned link layer A may switch the transmission rate of the master device to the transmission rate specified in the control message, the link layer B may switch the transmission rate of the slave device to the transmission rate specified in the control message. In practical applications, the master device may switch its transmission rate, and the slave device may switch its transmission rate.

The operation at block S208: sending, by the link layer A, the first indication message to the device A.

The above-mentioned first indication message may indicate that the transmission rate switching may be completed. Specifically, the first indication message may be LE PHY Update Complete.

The operation at block S209: sending, by the link layer B, a second indication message to the device B.

The above-mentioned second indication message may indicate that the transmission rate switching is completed. Specifically, the second indication message may be the LE PHY Update Complete.

In simple terms, the slave device may execute the process of transmission rate switching initiated by the master device, and the master device may also execute the process of transmission rate switching initiated by the slave device. Specifically, the master device and the slave device may negotiate various parameters of a Bluetooth link layer based on the Bluetooth protocols supported by both parties, thereby determining and updating the various parameters of the Bluetooth link layer for both parties. Further, a communication link may be established to perform data communication based on the negotiated parameters.

In related art, for two electronic devices with an established Bluetooth connection, the communication link between the two electronic devices may be easily affected by factors such as distance, external interference or the like. As a result, the anti-interference capability under certain transmission rates may be poor, which may reduce communication efficiency.

Based on this, the embodiments of the present disclosure may provide the Bluetooth communication method. On the side of the first device, the method may include: performing the link communication with the second device according to the first modulation mode; in a case where it is detected that the quality of the link communication is less than the preset threshold, adjusting the modulation mode of the first device from the first modulation mode to the second modulation mode, and performing link communication with the second device according to the second modulation mode. The anti-interference capability of the second modulation mode may be greater than that of the first modulation mode. In this way, when the communication environment is found to deteriorate to a degree that business fluency cannot be guaranteed, the first device may proactively adjust, through the link layer, to the second modulation mode with a stronger anti-interference capability for communication, thereby enhancing the link quality and increasing the communication efficiency. Moreover, communication reliability may be further enhanced, and communication quality in Bluetooth scenarios such as listening to music, making phone calls or the like may be ensured.

The following describes various embodiments of the present disclosure in detail with reference to the accompanying drawings.

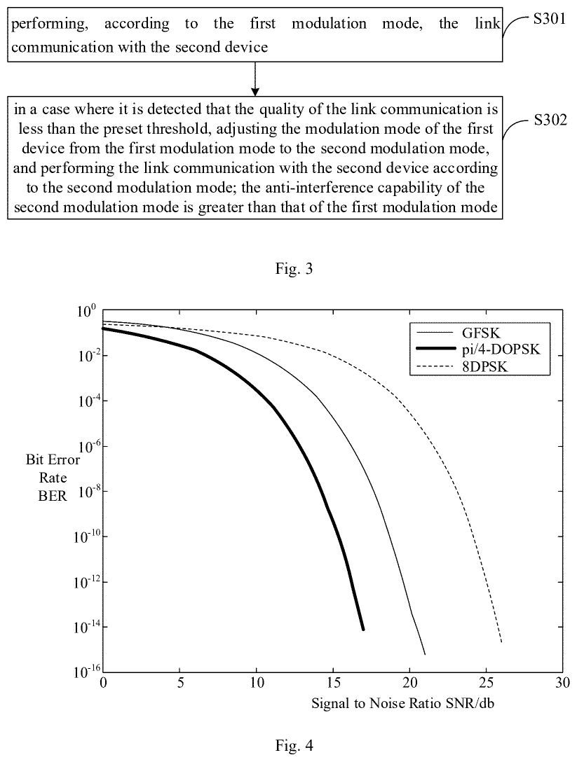

In some embodiment of the present disclosure, as illustrated in Fig. FIG. 3, FIG. 3 a schematic flowchart of the Bluetooth communication method according to an embodiment of the present disclosure. As illustrated in FIG. 3, the method may include the following operations:

The operation at block S301: performing, according to the first modulation mode, the link communication with the second device.

In the embodiment of the present disclosure, the Bluetooth communication method may be applied to the first device, and the first device may establish the Bluetooth connection with the second device. The Bluetooth connection may support a plurality of modulation modes, such as the first modulation mode, the second modulation mode, the third modulation mode or the like.

In the embodiment of the present disclosure, the first device may be the master device and the second device may be the slave device. In some embodiments, the first device may be the slave device and the second device may be the master device, which is not specifically restricted herein.

In the embodiment of the present disclosure, after the first device and the second device establish the Bluetooth connection, the two parties will negotiate and determine the modulation mode. Specifically, the first device may send the first negotiation message to the second device. The first negotiation message may be configured to indicate the modulation mode preferentially used by the first device and the second device as determined by the first device. The second device may send the second negotiation message to the first device. The second negotiation message may be configured to indicate the modulation mode preferentially used by the first device and the second device as determined by the second device. The first device may send the indication message to the second device. The indication message may be configured to indicate that, the first modulation mode may be used between the first device and the second device. In this way, after negotiation between the first device and the second device, the link communication may be performed according to the first modulation mode.

In the embodiment of the present disclosure, different modulation modes may correspond to different transmission rates. In other words, after negotiation between the first device and the second device, if both the first device and the second device support the first rate, the link communication may be performed according to the first rate.

The operation at block S302: in a case where it is detected that the quality of the link communication is less than the preset threshold, adjusting the modulation mode of the first device from the first modulation mode to the second modulation mode, and performing the link communication with the second device according to the second modulation mode. The anti-interference capability of the second modulation mode may be greater than that of the first modulation mode.

In the embodiment of the present disclosure, the operation of establishing the Bluetooth connection between the first device and the second device may specifically mean that, the first device and the second device may perform the link communication using a Bluetooth physical channel. The Bluetooth physical channel may be any physical link between the first device and the second device. That is, detecting the quality of the link communication may specifically mean detecting the quality of the physical link between the first device and the second device, i.e., the link quality; then, determining, based on the link quality, whether to adjust the modulation mode of the first device.

In the embodiment of the present disclosure, in a case where the link quality is detected to be poor, i.e., the quality of the link communication is less than the preset threshold, the modulation mode of the first device may need to be adjusted from the first modulation mode to the second modulation mode. The second modulation mode may have a relatively stronger anti-interference capability. The following may describe the link quality in detail through several possible implementation manners.

In a possible implementation manner, detecting that the quality of the link communication is less than the preset threshold may include: determining the number of consecutive retransmissions of data sent by the first device; in a case where the number of consecutive retransmissions is greater than the first threshold, determining that the quality of the link communication is less than the preset threshold.

In another possible implementation manner, detecting that the quality of the link communication is less than the preset threshold may include: determining the Packet Error Rate (PER) of the data sent by the first device; in a case where the packet error rate is greater than the second threshold, determining that the quality of the link communication is less than the preset threshold.

In yet another possible implementation manner, detecting that the quality of the link communication is less than the preset threshold may include: determining the received signal strength indicator (RSSI) message of the data received by the first device; in a case where the received signal strength indicator message is less than the third threshold, determining that the quality of the link communication is less than the preset threshold.

In still another possible implementation manner, detecting that the quality of the link communication is less than the preset threshold may include: determining the Bit Error Rate (BER) of the data sent by the first device; in a case where the bit error rate is greater than the fourth threshold, determining that the quality of the link communication is less than the preset threshold.

In the embodiment of the present disclosure, the preset threshold, as well as the first threshold, the second threshold, the third threshold, or the fourth threshold, are all pre-set parameter measurement indicators, which may be configured to determine whether the quality of the link communication deteriorates.

In the embodiment of the present disclosure, whether the quality of the link communication deteriorates may generally be determined based on whether the number of consecutive retransmissions may be greater than the first threshold. In addition, whether the quality of the link communication deteriorates may also be determined based on parameters such as the packet error rate, the bit error rate, the RSSI message or the like. Further, whether the quality of the link communication deteriorates may be determined based on a combination of at least two of parameters such as the number of consecutive retransmissions, the bit error rate, the packet error rate, the RSSI message or the like, which may be not specifically restricted herein.

For example, in the case of a combination of at least two parameters, in a possible implementation manner, the operation of detecting that the quality of the link communication is less than the preset threshold may include: determining the number of consecutive retransmissions of data sent by the first device and the packet error rate of the data sent by the first device; in a case where the number of consecutive retransmissions is greater than the first threshold and the packet error rate is greater than the second threshold, determining that the quality of the link communication is less than the preset threshold. In another possible implementation manner, the operation of detecting that the quality of the link communication is less than the preset threshold may include: determining the number of consecutive retransmissions of data sent by the first device and the received signal strength indicator message of the data received by the first device; in a case where the number of consecutive retransmissions is greater than the first threshold and the received signal strength indicator message is less than the third threshold, determining that the quality of the link communication is less than the preset threshold. This is not specifically restricted herein.

In some embodiments, the operation of adjusting the modulation mode of the first device from the first modulation mode to the second modulation mode may include: adjusting the modulation mode of the first device from the first modulation mode to the second modulation mode through the link layer of the first device.

That is, in a case where the first device detects that the link quality deteriorates, i.e., the quality of the link communication is less than the preset threshold, the link layer of the first device may proactively adjust the modulation mode of the first device to the second modulation mode. The second modulation mode may have a stronger anti-interference capability. In this way, the communication efficiency may be increased.

Further, in a case where it is detected that the quality of the link communication is less than the preset threshold, i.e., the link quality deteriorates, if the first device also expects the second device to switch to the second modulation mode, in some embodiments, the method may further include: sending a first control message to the second device. The first control message may be configured to instruct the second device to adjust its own modulation mode to the second modulation mode.

In the embodiment of the present disclosure, if the first device may be adjusted to the second modulation mode, and when the link quality deteriorates, it may be expected that the second device may also be adjusted to the second modulation mode at this time, the link layer may also be used for negotiation to guide the second device to adjust to the second modulation mode.

Specifically, in the embodiment of the present disclosure, the link layer of the first device may send the first control message to the link layer of the second device, the link layer of the second device may send a first confirmation message to the link layer of the first device. The link layer of the second device may control the modulation mode of the second device to be adjusted to the second modulation mode.

In some embodiments, the modulation modes supported by the Bluetooth connection may include: the gaussian frequency shift keying (GFSK) modulation mode, the π/4-differential quadrature phase shift keying (π/4-DQPSK) modulation mode, and the differential 8-phase shift keying (8DPSK) modulation mode.

The anti-interference capability of the 8DPSK modulation mode may be less than that of the GFSK modulation mode. The anti-interference capability of the GFSK modulation mode may be less than that of the π/4-DQPSK modulation mode.

In the embodiment of the present disclosure, the Bluetooth connection may mainly support three modulation modes, namely: the 8DPSK modulation mode, the π/4-DQPSK modulation mode, and the GFSK modulation mode. The Bluetooth connection may be not limited thereto. Among these three modulation modes, different modulation modes may have different requirements for signal to noise ratio (SNR). FIG. 4 is a schematic diagram of curves between the SNR and the bit error rate under different modulation modes according to an embodiment of the present disclosure. As illustrated in FIG. 4, the dashed line represents the curve for the 8DPSK modulation mode, the solid line represents the curve for the GFSK modulation mode, and the bold solid line represents the curve for the π/4-DQPSK modulation mode.

As may be seen from FIG. 4, among these three modulation modes, the π/4-DQPSK modulation mode may require the lowest SNR, which means that encoding using with the π/4-DQPSK modulation mode may have the strongest anti-interference capability.

In the embodiment of the present disclosure, since the anti-interference capability of the first modulation mode is less than that of the second modulation mode, in a case where the first modulation mode is the 8DPSK modulation mode, the second modulation mode may be the π/4-DQPSK modulation mode or the GFSK modulation mode. In some embodiments, in a case where the first modulation mode is the GFSK modulation mode, the second modulation mode may be the π/4-DQPSK modulation mode.

In a specific embodiment, the first modulation mode may be the 8DPSK modulation mode, the second modulation mode may be the π/4-DQPSK modulation mode. The anti-interference capability of the 8DPSK modulation mode may be less than that of the π/4-DQPSK modulation mode.

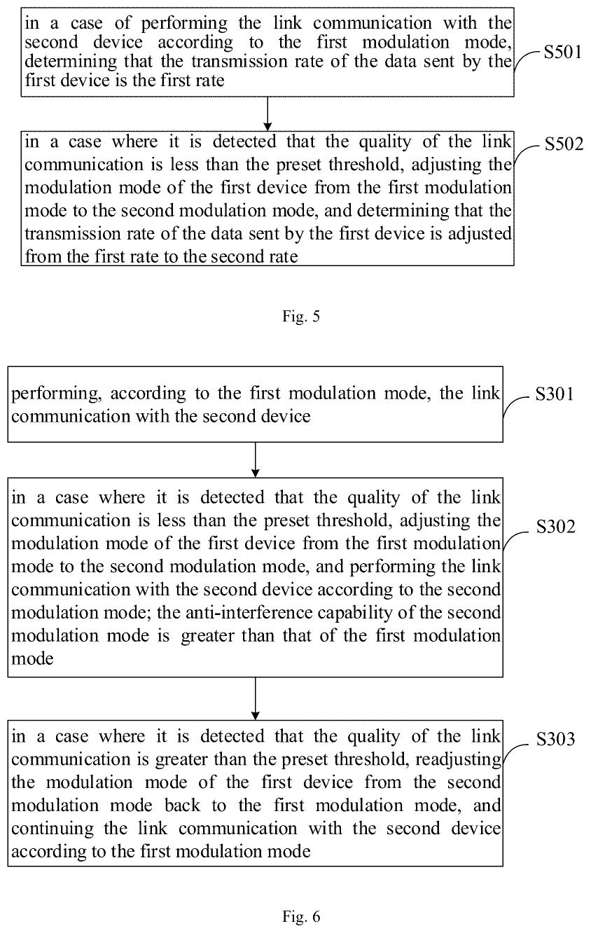

Further, different modulation modes may correspond to different transmission rates. In some embodiments, as illustrated in FIG. 5, the method may further include the following operations at the blocks of FIG. 5.

The operation at block S501: in a case of performing the link communication with the second device according to the first modulation mode, determining that the transmission rate of the data sent by the first device may be the first rate.

The operation at block S502: in a case where it is detected that the quality of the link communication is less than the preset threshold, adjusting the modulation mode of the first device from the first modulation mode to the second modulation mode, and determining that the transmission rate of the data sent by the first device may be adjusted from the first rate to the second rate.

In the embodiment of the present disclosure, the Bluetooth may support basic rate (BR) and enhanced data rate (EDR). The basic rate may include an operating mode, i.e., BR 1M. The operating mode may mean the BR mode with a rate of 1 Mbps. The enhanced data rate may include two operating modes, i.e., EDR 2M and EDR 3M. The EDR 2M may have a rate of 2 Mbps, and the EDR 3M may have a rate of 3 Mbps.

In the embodiment of the present disclosure, different modulation modes may correspond to different transmission rates. Specifically, in the BR mode, the rate may be 1 Mbps, and the modulation mode may be the GFSK modulation mode. In the EDR 2M mode, the rate may be 2 Mbps, and the modulation mode may be the π/4-DQPSK modulation mode. In the EDR 3M mode, the rate may be 3 Mbps, and the modulation mode may be the 8DPSK modulation mode.

For example, assuming that the modulation mode negotiated during the Bluetooth connection is the 8DPSK modulation mode, and at that time, the rate may be 3 Mbps. In a case where the quality of the communication link is detected to deteriorate, the link layer of the first device may adjust the modulation mode of the first device to the π/4-DQPSK modulation mode, the π/4-DQPSK modulation mode may have a stronger anti-interference capability. In this case, the rate may be 2 Mbps. The communication quality may thus be ensured. The specific reason may be that, the rate may be essentially traded for reliability. In a poor communication environment, if the device continues to operate at 3 Mbps, a large number of retransmissions may occur, which would instead result in a low transmission rate. While the device operates at 2 Mbps, the quality of common Bluetooth scenarios, such as listening to music, making phone calls or the like, may be ensured, the communication efficiency may be ensured.

Further, in the embodiment of the present disclosure, when the quality of the communication link becomes better, the modulation mode may also be readjusted to one with a weaker anti-interference capability. In some embodiments, after performing the link communication with the second device according to the second modulation mode, the method may further include: in a case where it is detected that, the quality of the link communication is greater than the preset threshold, adjusting the modulation mode of the first device from the second modulation mode to the third modulation mode, and continuing the link communication with the second device according to the third modulation mode. The anti-interference capability of the third modulation mode may be less than that of the second modulation mode.

In the embodiment of the present disclosure, after performing the link communication with the second device according to the second modulation mode, in a case where the link quality becomes better, i.e., the quality of the link communication may be detected to be greater than the preset threshold, the modulation mode of the first device may be further adjusted, through the link layer of the first device, from the second modulation mode to the third modulation mode. The third modulation mode may have a weaker anti-interference capability.

In a specific embodiment, the third modulation mode may be the first modulation mode. As illustrated in FIG. 6, after the operation at block S302, the method may further include the operation at block S303: in a case where it is detected that the quality of the link communication is greater than the preset threshold, readjusting the modulation mode of the first device from the second modulation mode back to the first modulation mode, and continuing the link communication with the second device according to the first modulation mode.

In other words, after negotiation between the first device and the second device, the first device and the second device may perform the link communication using the first modulation mode. In a case where the link quality is detected to deteriorate, the modulation mode of the first device may be adjusted from the first modulation mode to the second modulation mode, and then the link communication may be performed using the second modulation mode. However, in a case where the link quality is detected to become better, the modulation mode of the first device may be readjusted back to the first modulation mode, such that the first device and the second device may still perform the link communication using the first modulation mode.

In some embodiments, in a case where it is detected that the quality of the link communication is greater than the preset threshold, the method may further include: sending the second control message to the second device. The second control message may be configured to instruct the second device to adjust its own modulation mode to the third modulation mode.

In the embodiment of the present disclosure, in a case where the first device is adjusted to the third modulation mode, the third modulation mode may have a weaker anti-interference capability, and when the link quality improves, if it is expected that the second device may also be adjusted to the third modulation mode at this time, the link layer may also be used for negotiation to guide the second device to adjust to the third modulation mode.

Specifically, in the embodiment of the present disclosure, the link layer of the first device may send the second control message to the link layer of the second device, the link layer of the second device may send a second confirmation message to the link layer of the first device. The link layer of the second device may control the modulation mode of the second device to be adjusted to the third modulation mode.

For example, if the modulation mode negotiated by the first device and the second device for the link communication is the 8DPSK modulation mode with a rate of 3 Mbps, in a case where the link quality is detected to deteriorate, the modulation mode of the first device may be adjusted from the 8DPSK to the π/4-DQPSK modulation mode. Then the link communication may be performed using the π/4-DQPSK modulation mode with a matched transmission rate of 2 Mbps. However, in a case where the link quality is detected to become better, the modulation mode of the first device may be readjusted back to the 8DPSK modulation mode, so that the transmission rate between the first device and the second device may remain 3 Mbps.

In the embodiment of the present disclosure, modulation and demodulation may occur in a corresponding manner. Therefore, the modulation mode herein may also be referred to as a “modulation and demodulation mode”. For example, the first modulation mode may also be called a first modulation and demodulation mode, and the second modulation mode may also be called a second modulation and demodulation mode. For example, if the first device performs modulation and encoding according to the π/4-DQPSK, then correspondingly, the second device may need to perform a demodulation processing on the received data according to the π/4-DQPSK.

The present embodiment may provide the Bluetooth communication method applied to the first device. First, the link communication may be performed with the second device according to the first modulation mode. Then, in a case where the quality of the link communication is detected to be less than the preset threshold, the modulation mode of the first device may be adjusted from the first modulation mode to the second modulation mode, and the link communication may be performed with the second device according to the second modulation mode. The anti-interference capability of the second modulation mode may be greater than that of the first modulation mode. In this way, in a case where the communication environment is detected to deteriorate to a degree that the service fluency cannot be guaranteed, the first device may proactively adjust to the second modulation mode, which has a stronger anti-interference capability, through the link layer for communication, thereby increasing the link quality and the communication efficiency. Moreover, it may also enhance the communication reliability and ensure communication quality in Bluetooth scenarios such as listening to music, making phone calls or the like.

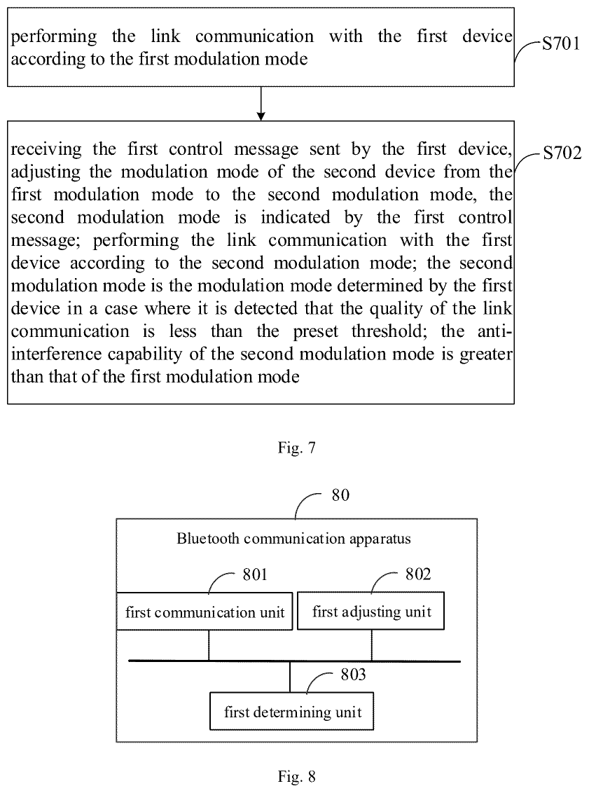

In another embodiment of the present disclosure, as illustrated in FIG. 7, FIG. 7 is a schematic flowchart of yet another Bluetooth communication method according to an embodiment of the present disclosure. As illustrated in FIG. 7, the method may include the following operations at blocks of FIG. 7.

The operation at block S701: performing the link communication with the first device according to the first modulation mode.

In the embodiment of the present disclosure, the Bluetooth communication method may be applied to the second device, and the second device may establish the Bluetooth connection with the first device. The Bluetooth connection may support a plurality of modulation modes, such as the first modulation mode, the second modulation mode, the third modulation mode or the like.

In the embodiment of the present disclosure, the first device may be the master device, and the second device may be the slave device. In some embodiments, the first device may be the slave device, and the second device may be the master device, which may be not specifically restricted herein.

In the embodiment of the present disclosure, after the second device and the first device establish the Bluetooth connection, the first device and the second device may negotiate and determine the modulation mode. Specifically, the first device may send the first negotiation message to the second device. The first negotiation message may be configured to indicate the modulation mode preferentially used by the first device and the second device as determined by the first device. The second device may send the second negotiation message to the first device. The second negotiation message may be configured to indicate the modulation mode preferentially used by the first device and the second device as determined by the second device. The first device may send an indication message to the second device. The indication message may be configured to indicate that the first modulation mode may be used between the first device and the second device. In this way, after negotiation between the first device and the second device, the link communication may be performed according to the first modulation mode.

The operation at block S702: receiving the first control message sent by the first device, adjusting the modulation mode of the second device from the first modulation mode to the second modulation mode, the second modulation mode may be indicated by the first control message, and performing the link communication with the first device according to the second modulation mode. The second modulation mode may be the modulation mode determined by the first device in a case where it is detected that the quality of the link communication may be less than the preset threshold. The anti-interference capability of the second modulation mode may be greater than that of the first modulation mode.

In the embodiment of the present disclosure, in a case where the first device detects that the quality of the link communication is less than the preset threshold, i.e., the link quality deteriorates, the modulation mode of the first device may be adjusted from the first modulation mode to the second modulation mode at this time. If it is also expected that the second device adjusts to the second modulation mode, a negotiation process through the link layer may be performed, and the first control message may be sent to the second device to adjust the modulation mode of the second device to the second modulation mode. The second modulation mode may be indicated by the first control message.

In some embodiments, the modulation modes supported by the Bluetooth connection may include: the GFSK modulation mode, the π/4-DQPSK modulation mode, and the 8DPSK modulation mode. Among them, the anti-interference capability of the 8DPSK modulation mode may be less than that of the GFSK modulation mode. The anti-interference capability of the GFSK modulation mode may be less than that of the π/4-DQPSK modulation mode.

In a specific embodiment, the first modulation mode may be the 8DPSK modulation mode; the second modulation mode may be the π/4-DQPSK modulation mode. For example, after the Bluetooth connection is established between the first device and the second device, the modulation mode negotiated by the first device and the second device may be the 8DPSK modulation mode, and the link communication may be performed according to the 8DPSK modulation mode. However, in a case where the first device detects that the link quality deteriorates, the first device may adjust its modulation mode from the 8DPSK to the π/4-DQPSK modulation mode at this time, and may also expect the modulation mode of the second device to be adjusted accordingly. Then the first device may send the first control message to the second device through the link layer, so that the modulation mode of the second device may be also adjusted to the π/4-DQPSK modulation mode accordingly.

In the embodiment of the present disclosure, different modulation modes may correspond to different transmission rates. Specifically, in the BR mode, the rate may be 1 Mbps, and the modulation mode may be the GFSK modulation mode. In the EDR 2M mode, the rate may be 2 Mbps, and the modulation mode may be the π/4-DQPSK modulation mode. In the EDR 3M mode, the rate may be 3 Mbps, and the modulation mode may be the 8DPSK modulation mode.

For example, assuming that the modulation mode negotiated during the Bluetooth connection is the 8DPSK modulation mode, at this time, the rate may be 3 Mbps. In a case where the quality of the communication link is detected to deteriorate, the link layer of the first device may adjust the modulation mode of the first device to the π/4-DQPSK modulation mode. The π/4-DQPSK modulation mode may have a stronger anti-interference capability. The rate at this time may be 2 Mbps. If it is also expected that the modulation mode of the second device is adjusted accordingly, the second device may also adjust its modulation mode to the π/4-DQPSK modulation mode after receiving the first control message sent by the first device. The corresponding rate may be 2 Mbps. Thus, the communication quality may be ensured, and the communication efficiency may be enhanced.

Further, in the embodiment of the present disclosure, in a case where the quality of the communication link becomes better, the second device may also readjust to the modulation mode with a weaker anti-interference capability. In some embodiments, after performing the link communication with the first device according to the second modulation mode, the method may further include: receiving the second control message sent by the first device, adjusting the modulation mode of the second device from the second modulation mode to the third modulation mode, the third modulation mode may be indicated by the second control message, and performing the link communication with the first device according to the third modulation mode. The third modulation mode may be the modulation mode determined by the first device in a case where it is detected that the quality of the link communication is greater than the preset threshold. The anti-interference capability of the third modulation mode may be less than that of the second modulation mode.

In the embodiment of the present disclosure, in a case where the first device is adjusted to the third modulation mode, the third modulation mode may have a weaker anti-interference capability, and when the link quality becomes better, if it is expected that the second device may also be adjusted to the third modulation mode at this time, the link layer may also be used for negotiation to guide the second device to adjust to the third modulation mode.

In a specific embodiment, the third modulation mode may be the first modulation mode. That is to say, after negotiation between the first device and the second device, the first device and the second device may perform the link communication using the first modulation mode. In a case where the link quality is detected to deteriorate, the modulation mode of the first device may be adjusted from the first modulation mode to the second modulation mode, then the link communication may be performed using the second modulation mode. However, when the link quality is detected to become better, the modulation mode of the first device may be readjusted back to the first modulation mode If the modulation mode of the second device is also expected to be adjusted accordingly, the second device may restore and adjust its modulation mode to the first modulation mode after receiving the second control message sent by the first device, and then perform the link communication at the matched rate.

The present embodiment may provide the Bluetooth communication method applied to the second device. First, the link communication may be performed with the first device according to the first modulation mode. Then, the first control message sent by the first device may be received, the modulation mode of the second device may be adjusted from the first modulation mode to the second modulation mode, the second modulation mode may be indicated by the first control message. The link communication may be performed with the first device according to the second modulation mode. The second modulation mode may be the modulation mode determined by the first device in a case where it is detected that the quality of the link communication is less than the preset threshold. The anti-interference capability of the second modulation mode may be greater than that of the first modulation mode. In this way, in a case where the communication environment is detected to deteriorate to a degree that the service fluency cannot be guaranteed, and the first device also expects the modulation mode of the second device to be adjusted accordingly, the modulation mode of the second device may be adjusted, through the guidance and negotiation of the link layer, to the second modulation mode with a stronger anti-interference capability for communication according to the received first control message, thereby increasing the communication efficiency. Moreover, the communication reliability may be enhanced, and the communication quality in Bluetooth scenarios such as listening to music, making phone calls or the like may be guaranteed.

In yet another embodiment of the present disclosure, based on the Bluetooth communication method described in the above-mentioned embodiments, the Bluetooth may support three rates, including: a code rate of 1 Mbps for the BR mode, the matched modulation and demodulation mode may be the GFSK; and, two rates for the EDR mode. The two rates may include: 2 Mbps, the matched modulation and demodulation mode may be the π/4-DQPSK; and, 3 Mbps, the matched modulation and demodulation mode may be the 8DPSK.

In practical applications, two devices may usually negotiate a rate after establishing the Bluetooth connection, and the rate may be not dynamically adjusted during the connection process. For example, when both the first device and the second device support the 3 Mbps, the modulation and demodulation mode 8DPSK matching with the 3 Mbps may be selected for the link communication.

As may be seen from FIG. 4, different modulation and demodulation modes may have different requirements for the SNR. Among them, the π/4-DQPSK may require a relatively low SNR, which means that the π/4-DQPSK encoding may have a strong anti-interference capability.

In the embodiment of the present disclosure, when the rate negotiated during the Bluetooth connection is 3 Mbps, and the link quality is detected to be poor, a LMP layer may be configured to proactively adjust to the modulation and demodulation mode π/4-DQPSK (2 Mbps) with a stronger anti-interference capability, which may greatly increase the communication efficiency. That is to say, through the detection of the link quality, in a case where a cumulative number of consecutive retransmissions reaches a certain value and the service fluency cannot be guaranteed, the rate may be automatically adjusted to the 2 Mbps with a stronger anti-interference capability. In other words, the rate may be automatically reduced. At this time, the π/4-DQPSK modulation and demodulation mode may be configured for encoding, which may improve the communication reliability.

In the embodiment of the present disclosure, a specific implementation of the above-mentioned embodiments may be described in detail through the above embodiments. It may be seen that, with the technical solutions of the above-mentioned embodiments, in a case where the air environment suddenly deteriorates, the communication rate may be automatically detected and adjusted to the modulation and demodulation mode π/4-DQPSK (2 Mbps) with a stronger anti-interference capability, thereby ensuring the communication quality and further increasing the communication efficiency. Here, the rate may be actually traded for reliability. In fact, in a poor environment, if the rate continues at 3 Mbps, a large number of retransmissions would occur, which will instead result in a low transmission rate. While at the rate of 2 Mbps, the quality of the common Bluetooth scenarios such as listening to music and making phone calls may be guaranteed.

In yet another embodiment of the present disclosure, based on a same inventive concept as the above-mentioned embodiments, as illustrated in FIG. 8, FIG. 8 is a schematic diagram of the composition structure of the Bluetooth communication apparatus according to an embodiment of the present disclosure. As illustrated in FIG. 8, a Bluetooth communication apparatus 80 may include a first communication unit 801 and a first adjusting unit 802.

The first communication unit 801 may be configured to perform the link communication with the second device according to the first modulation mode.

The first adjusting unit 802 may be configured to adjust the modulation mode of the first device from the first modulation mode to the second modulation mode in a case where it is detected that the quality of the link communication is less than the preset threshold.

The first communication unit 801 may be further configured to perform the link communication with the second device according to the second modulation mode. The anti-interference capability of the second modulation mode may be greater than that of the first modulation mode.

In some embodiments, the first communication unit 801 may be further configured to send the first control message to the second device in a case where it is detected that the quality of the link communication is less than the preset threshold. The first control message may be configured to instruct the second device to adjust its own modulation mode to the second modulation mode.

In some embodiments, as illustrated in FIG. 8, the Bluetooth communication apparatus 80 may further include a first determining unit 803. The first determining unit 803 may be configured to: determine the number of consecutive retransmissions of the data sent by the first device; and, in a case where the number of consecutive retransmissions is greater than the first threshold, determine that the quality of the link communication is less than the preset threshold.

In some embodiments, the first determining unit 803 may be further configured to: determine the packet error rate of the data sent by the first device; and, in a case where the packet error rate is greater than the second threshold, determine that the quality of the link communication is less than the preset threshold.

In some embodiments, the first determining unit 803 may be further configured to: determine the received signal strength indicator message of the data received by the first device; and, in a case where the received signal strength indicator message is less than the third threshold, determine that the quality of the link communication is less than the preset threshold.

In some embodiments, the modulation modes supported by the Bluetooth connection may include: the GFSK modulation mode, the π/4-DQPSK modulation mode, and the 8DPSK modulation mode. The anti-interference capability of the 8DPSK modulation mode may be less than that of the GFSK modulation mode. The anti-interference capability of the GFSK modulation mode may be less than that of the π/4-DQPSK modulation mode.

In some embodiments, the first modulation mode may be the 8DPSK modulation mode. The second modulation mode may be the π/4-DQPSK modulation mode.

In some embodiments, different modulation modes may correspond to different transmission rates. Correspondingly, the first determining unit 803 may be further configured to determine that the transmission rate of the data sent by the first device may be the first rate when performing the link communication with the second device according to the first modulation mode.

The first adjusting unit 802 may be further configured to, in a case where it is detected that the quality of the link communication is less than the preset threshold, adjust the modulation mode of the first device from the first modulation mode to the second modulation mode, and determine that the transmission rate of the data sent by the first device is adjusted from the first rate to the second rate.

In some embodiments, the first adjusting unit 802 may be further configured to, after performing the link communication with the second device according to the second modulation mode, in a case where it is detected that the quality of the link communication is greater than the preset threshold, adjust the modulation mode of the first device from the second modulation mode to the third modulation mode; and, continue the link communication with the second device according to the third modulation mode. The anti-interference capability of the third modulation mode may be less than that of the second modulation mode.

In some embodiments, the first communication unit 801 may be further configured to: send the second control message to the second device in a case where it is detected that the quality of the link communication is greater than the preset threshold. The second control message may be configured to instruct the second device to adjust its own modulation mode to the third modulation mode.

In the embodiment of the present disclosure, the Bluetooth communication apparatus 80 may be applied to the first device. Those skilled in the art should understand that, the relevant description of the Bluetooth communication apparatus in the embodiment of the present disclosure may be understood with reference to the relevant description of the Bluetooth communication method in the above-mentioned embodiments.

The present embodiment may provide the Bluetooth communication apparatus, which may be integrated into the first device. In a case where the communication environment is detected to deteriorate to a degree that the service fluency cannot be guaranteed, the first device may proactively adjust to the second modulation mode with a stronger anti-interference capability through the link layer for communication, thereby enhancing the link quality and increasing the communication efficiency. Moreover, the communication reliability may further be increased, and the communication quality in Bluetooth scenarios such as listening to music, making phone calls or the like may be guaranteed.

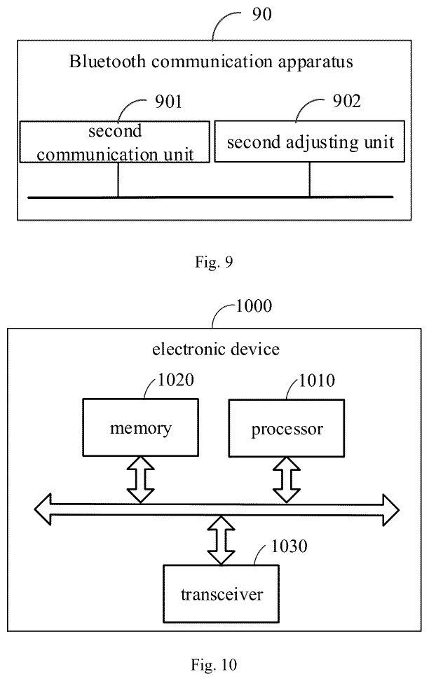

Based on the same inventive concept as the above-mentioned embodiments, as illustrated in FIG. 9, FIG. 9 is a schematic diagram of the composition structure of another Bluetooth communication apparatus according to an embodiment of the present disclosure. As illustrated in FIG. 9, a Bluetooth communication apparatus 90 may include a second communication unit 901 and a second adjusting unit 902.

The second communication unit 901 may be configured to perform the link communication with the first device according to the first modulation mode. The second communication unit 901 may be further configured to receive the first control message sent by the first device.

The second adjusting unit 902 may be configured to adjust the modulation mode of the second device from the first modulation mode to the second modulation mode. The second modulation mode may be indicated by the first control message.

The second communication unit 901 may be further configured to perform the link communication with the first device according to the second modulation mode. The second modulation mode may be the modulation mode determined by the first device in a case where it is detected that the quality of the link communication is less than the preset threshold. The anti-interference capability of the second modulation mode may be greater than that of the first modulation mode.

In some embodiments, the second communication unit 901 may be further configured to receive the second control message sent by the first device after performing the link communication with the first device according to the second modulation mode.

The second adjusting unit 902 may be further configured to: adjust the modulation mode of the second device from the second modulation mode to the third modulation mode, the third modulation mode may be indicated by the second control message; and, perform the link communication with the first device according to the third modulation mode. The third modulation mode may be the modulation mode determined by the first device in a case where it is detected that the quality of the link communication is greater than the preset threshold. The anti-interference capability of the third modulation mode may be less than that of the second modulation mode.

In the embodiment of the present disclosure, the Bluetooth communication apparatus 90 may be applied to the second device. Those skilled in the art should understand that the relevant description of the Bluetooth communication apparatus in the embodiment of the present disclosure may be understood with reference to the relevant description of the Bluetooth communication method in the above-mentioned embodiments.

The present embodiment provides the Bluetooth communication apparatus, which may be integrated into the second device. In a case where the communication environment is detected to deteriorate to a degree that service fluency cannot be guaranteed, and the first device also expects the modulation mode of the second device to be adjusted accordingly, the modulation mode of the second device may be adjusted, through guidance and negotiation of the link layer, to the second modulation mode with a stronger anti-interference capability for communication according to the received first control message. In this way, the communication efficiency may be increased. Moreover, the communication reliability may be further enhanced, the communication quality in Bluetooth scenarios such as listening to music, making phone calls or the like may be guaranteed.

In yet another embodiment of the present disclosure, as illustrated in FIG. 10, FIG. 10 is a schematic diagram of the composition structure of an electronic device according to an embodiment of the present disclosure. As illustrated in FIG. 10, an electronic device 1000 may include a processor 1010 and a memory 1020. The memory 1020 may store a computer program. The processor 1010 may configured to call and run the computer program from the memory 1020 to implement the Bluetooth communication method described in any one of the above-mentioned embodiments. Here, the electronic device 1000 may be the first device or the second device.

In some embodiments, the memory 1020 may be a separate device independent of the processor 1010, or may be integrated into the processor 1010.

In some embodiments, as illustrated in FIG. 10, the electronic device 1000 may further include a transceiver 1030. The processor 1010 may control the transceiver 1030 to communicate with another device. Specifically, the transceiver 1030 may send message or data to another device, or receive message or data sent by another device.

The transceiver 1030 may include a transmitter and a receiver. The transceiver 1030 may further include antennas. The number of antennas may be one or more.

In some embodiments, the present disclosure may further provide another composition of an electronic device. The electronic device may include the Bluetooth communication apparatus 80 or the Bluetooth communication apparatus 90 described in any of the above-mentioned embodiments.

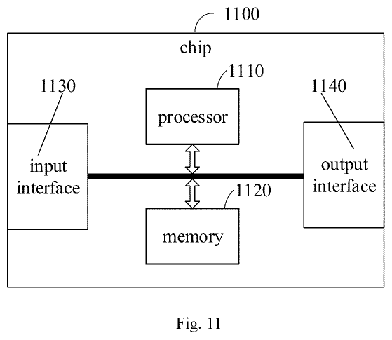

In yet another embodiment of the present disclosure, as illustrated in FIG. 11, FIG. 11 is a schematic diagram of the composition structure of a chip according to an embodiment of the present disclosure. As illustrated in FIG. 11, a chip 1100 may include a processor 1110. The processor 1110 may be configured to call and run the computer program from the memory to implement the Bluetooth communication method described in any of the above-mentioned embodiments.

In some embodiments, as illustrated in FIG. 11, the chip 1100 may further include a memory 1120. The processor 1110 may be configured to call and run a computer program from the memory 1120 to implement the Bluetooth communication method described in any of the above-mentioned embodiments.

In some embodiments, the memory 1120 may be a separate device independent of the processor 1110, or may be integrated into the processor 1110.

In some embodiments, the chip 1100 may further include an input interface 1130. The processor 1110 may control the input interface 1130 to communicate with another device or chip. Specifically, the processor 111 may be configured to obtain message or data sent by another device or chip.

In some embodiments, the chip 1100 may further include an output interface 1140. The processor 1110 may control the output interface 1140 to communicate with another device or chip. Specifically, the processor 1110 may be configured to output message or data to another device or chip.

In some embodiments, the chip may be applied to the first device in the embodiments of the present disclosure, details of which would not be elaborated here for brevity.

In some embodiments, the chip may be applied to the second device in the embodiments of the present disclosure, details of which would not be elaborated here for brevity.

It should be understood that, the chip mentioned in the embodiments of the present disclosure may also be referred to as a system-level chip, a system chip, a chip system, a system-on-chip or the like.

The processor in the embodiments of the present disclosure may be an integrated circuit chip with information processing capability. During implementation, the operations of the above-mentioned process embodiments may be completed by integrated logic circuits of hardware in the processor or instructions in the form of software. The above-mentioned processor may be a general-purpose processor, a digital signal processor (DSP), an application specific integrated circuit (ASIC), a field programmable gate array (FPGA), or another programmable logic device, a discrete gate or a transistor logic device, or a discrete hardware component. The methods, operations, and logic block diagrams disclosed in the embodiments of the present disclosure may be implemented or executed. The general-purpose processor may be a microprocessor, or the processor may also be any conventional processor or the like. The operations of the method disclosed in conjunction with the embodiments of the present disclosure may be directly implemented by a hardware decoding processor, or implemented by a combination of hardware and software modules in the decoding processor. The software modules may be located in mature storage media in the art, such as a random-access memory, a flash memory, a read-only memory, a programmable read-only memory, an electrically erasable programmable memory, a register, or the like. The storage medium may be located in the memory. The processor may be configured to read the information in the memory and complete the operations of the above-mentioned method in combination with its hardware.

The memory in the embodiments of the present disclosure may be volatile memory or non-volatile memory, or may include both the volatile memory and the non-volatile memory. Among them, the non-volatile memory may be a read-only memory (ROM), a programmable ROM (PROM), an erasable PROM (EPROM), an electrically erasable PROM (EEPROM), or a flash memory. The volatile memory may be a random-access Memory (RAM), which may be used as an external cache. By way of example and not limitation, many forms of RAM may be available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and, a direct rambus RAM (DR RAM). The memory described herein may be intended to include, but may be not limited to, these and any other suitable types of memory.

The embodiments described in the present disclosure may be implemented by hardware, software, firmware, middleware, microcode, or a combination thereof. For hardware implementation, the processing unit may be implemented in one or more application specific integrated circuits (ASIC), digital signal processors (DSP), DSP devices (DSPD), programmable logic devices (PLD), field-programmable gate arrays (FPGA), general-purpose processors, controllers, microcontrollers, microprocessors, another electronic unit for performing the functions described in the present disclosure, or a combination thereof. For software implementation, the technologies described in the present disclosure may be implemented through modules (such as procedures, functions or the like) that are configured to execute the functions described in the present disclosure. The software code may be stored in the memory and executed by the processor. The memory may be implemented in the processor or outside the processor.

In yet another embodiment of the present disclosure, the embodiment of the present disclosure further provides a computer-readable storage medium for storing a computer program.

In some embodiments, the computer-readable storage medium may be applied to the first device in the above-mentioned embodiments. The computer program while being executed by at least one processor may enable the matched processes performed by the first device in various methods of the embodiments of the present disclosure, details of which would not be elaborated here for brevity.

In some embodiments, the computer-readable storage medium may be applied to the second device in the above-mentioned embodiments The computer program while being executed by at least one processor may enable the matched processes performed by the second device in various methods of the embodiments of the present disclosure, details of which would not be elaborated here for brevity.

The embodiments of the present disclosure may further provide a computer program product. The computer program product may include a computer program or instructions.

In some embodiments, the computer program product may be applied to the first device in the above-mentioned embodiments. The computer program or instructions may cause a computer to execute the matched processes performed by the first device in various methods of the embodiments of the present disclosure, details of which would not be elaborated here for brevity.

In some embodiments, the computer program product may be applied to the second device in the above-mentioned embodiments. The computer program or instructions may cause a computer to execute the matched processes performed by the second device in various methods of the embodiments of the present disclosure, details of which would not be elaborated here for brevity.

The embodiments of the present disclosure may further provide a computer program.

In some embodiments, the computer program may be applied to the first device in the above-mentioned embodiments. The computer program, while running on a computer, may cause the computer to execute the matched processes performed by the first device in various methods of the embodiments of the present disclosure, details of which would not be elaborated here for brevity.

In some embodiments, the computer program may be applied to the second device in the above-mentioned embodiments. The computer program, while running on a computer, may cause the computer to execute the matched processes performed by the second device in various methods of the embodiments of the present disclosure, details of which would not be elaborated here for brevity.

Those of ordinary skill in the art may recognize that, the units and algorithm operations of the examples described in conjunction with the disclosed embodiments of the present disclosure may be implemented by electronic hardware, or a combination of computer software and electronic hardware. Whether these functions are executed by hardware or software may depend on the specific application and design constraints of the technical solutions. Professional technicians may use different methods to implement the described functions for each specific application, but such implementation should not be considered beyond the scope of the present disclosure.

Those skilled in the art may clearly understand that, for the convenience and brevity of description, the specific operation processes of the devices and units described above may be referred to the corresponding processes in the above-mentioned method embodiments, details of which would not be elaborated here.

In the several embodiments provided in the present disclosure, the disclosed devices and methods may be implemented in another way. For example, the device embodiments described above may only be illustrative. For example, the division of the units may be only a logical function division. In an actual implementation, there may be other division approaches. For example, a plurality of units or components may be combined or integrated into another system, or some features may be ignored or not implemented. In addition, the displayed or discussed mutual coupling, direct coupling, or communication connection may be indirect coupling or communication connection through some interfaces, devices, or units, and may be in electrical, mechanical, or other forms.

The units described as separate components may or may not be physically separated. The components displayed as units may or may not be physical units. In other words, the units or components located in one place, or may be distributed to a plurality of network units. Some or all of the units may be selected according to actual needs to achieve the purpose of the object of the present disclosure.

In addition, various functionals unit in various embodiments of the present disclosure may be integrated into one processing unit, or each unit may exist physically alone, or two or more units may be integrated into one unit.

In a case where the functions are implemented in the form of software functional units and sold or used as independent products, they may be stored in a computer-readable storage medium. Based on such understanding, the technical solutions of the present disclosure, in essence, or the part that contributes to the existing technology, or part of the technical solutions, may be embodied in the form of a software product. The computer software product may be stored in a storage medium and may include several instructions to enable a computer device to execute all or part of the operations of the methods described in various embodiments of the present disclosure. The computer device may be a personal computer, a server, a network device or the like. The above-mentioned storage media may include: U disks, mobile hard disks, a read-only memory (ROM), a random-access memory (RAM), magnetic disks, optical disks, or another media that may store program codes.

In the present disclosure, the terms “include”, “comprise” or any other variants thereof may be intended to cover non-exclusive inclusion, so that a process, a method, an article or a device including a series of elements not only may include those elements, but also may include another element not explicitly listed, or elements inherent to such a process, method, article or device. Without more restrictions, an element defined by the sentence “including a . . . ” does not exclude the existence of another identical element in the process, method, article or device that may include the element.

The serial numbers of the above-mentioned embodiments of the present disclosure are only for description, and may not represent the advantages or disadvantages of the embodiments.

The methods disclosed in the several method embodiments provided in the present disclosure may be arbitrarily combined without conflict to obtain new method embodiments.

The features disclosed in the several product embodiments provided in the present disclosure may be arbitrarily combined without conflict to obtain new product embodiments.

The features disclosed in the several method or device embodiments provided in the present disclosure may be arbitrarily combined without conflict to obtain new method embodiments or device embodiments.

The above-mentioned descriptions are only specific implementations of the present disclosure, but the protection scope of the present disclosure may be not limited thereto. Any person skilled in the art may easily obtain changes or substitutions within the technical scope disclosed in the present disclosure, which should fall within the protection scope of the present disclosure. Therefore, the protection scope of the present disclosure shall be subject to the protection scope of the claims.

### INDUSTRIAL APPLICABILITY

In the embodiments of the present disclosure, on the side of the first device, the link communication may be performed with the second device according to the first modulation mode. In a case where it is detected that the quality of the link communication may be less than the preset threshold, the modulation mode of the first device may be adjusted from the first modulation mode to the second modulation mode, and the link communication may be performed with the second device according to the second modulation mode. On the side of the second device, the link communication may be performed with the first device according to the first modulation mode. The first control message sent by the first device may be received, the modulation mode of the second device may be adjusted from the first modulation mode to the second modulation mode. The second modulation mode may be indicated by the first control message. The link communication may be performed with the first device according to the second modulation mode. Among them, the second modulation mode may be the modulation mode determined by the first device in a case where it is detected that the quality of the link communication may be less than the preset threshold. The anti-interference capability of the second modulation mode may be greater than that of the first modulation mode. In this way, in a case where the communication environment is detected to deteriorate to a degree that service fluency cannot be guaranteed, the link layer may be configured to proactively adjust to the second modulation mode with a stronger anti-interference capability for communication. In this way, the link quality may be enhanced, and the communication efficiency may be increased. Moreover, the communication reliability may also be increased, and the communication quality in Bluetooth scenarios such as listening to music, making phone calls or the like may be increased.

1. A Bluetooth communication method, performed by a first device, a Bluetooth connection being established between the first device and a second device, wherein the method comprises:
performing, according to a first modulation mode, link communication with the second device; and
in a case where it is detected that a quality of the link communication is less than a preset threshold, adjusting a modulation mode of the first device from the first modulation mode to a second modulation mode, and performing the link communication with the second device according to the second modulation mode;
wherein an anti-interference capability of the second modulation mode is greater than that of the first modulation mode.

2. The method as claimed in claim 1, wherein in a case where it is detected that the quality of the link communication is less than the preset threshold, the method further comprises:
sending a first control message to the second device;
wherein the first control message is configured to instruct the second device to adjust its own modulation mode to the second modulation mode.

3. The method as claimed in claim 1, wherein detecting that the quality of the link communication is less than the preset threshold comprises:
determining a number of consecutive retransmissions of data sent by the first device; and
in a case where the number of consecutive retransmissions is greater than a first threshold, determining that the quality of the link communication is less than the preset threshold.

4. The method as claimed in claim 1, wherein detecting that the quality of the link communication is less than the preset threshold comprises:
determining a packet error rate of data sent by the first device; and
in a case where the packet error rate is greater than a second threshold, determining that the quality of the link communication is less than the preset threshold.

5. The method as claimed in claim 1, wherein detecting that the quality of the link communication is less than the preset threshold comprises:
determining a received signal strength indicator message for data received by the first device; and
in a case where the received signal strength indicator message is less than a third threshold, determining that the quality of the link communication is less than the preset threshold.

6. The method as claimed in claim 1, wherein modulation modes supported by the Bluetooth connection comprise: Gaussian frequency shift keying (GFSK) modulation mode, π/4-differential quadrature phase shift keying (π/4-DQPSK) modulation mode, and 8-differential phase shift keying (8DPSK) modulation mode;
wherein the anti-interference capability of the 8DPSK modulation mode is less than that of the GFSK modulation mode, and the anti-interference capability of the GFSK modulation mode is less than that of the π/4-DQPSK modulation mode.

7. The method as claimed in claim 6, wherein the first modulation mode is the 8DPSK modulation mode; and
wherein the second modulation mode is the π/4-DQPSK modulation mode.

8. The method as claimed in claim 1, wherein different modulation modes match with different transmission rates;
wherein the method further comprises:
while performing, according to the first modulation mode, the link communication with the second device, determining that a transmission rate of data sent by the first device is a first rate; and
in a case where it is detected that the quality of the link communication is less than the preset threshold, adjusting the modulation mode of the first device from the first modulation mode to the second modulation mode, and determining that the transmission rate of the data sent by the first device is adjusted from the first rate to a second rate.

9. The method as claimed in claim 1, wherein after performing, according to the second modulation mode, the link communication with the second device, the method further comprises:
in a case where it is detected that the quality of the link communication is greater than the preset threshold, adjusting the modulation mode of the first device from the second modulation mode to a third modulation mode, and continuing the link communication with the second device according to the third modulation mode;
wherein the anti-interference capability of the third modulation mode is less than that of the second modulation mode.

10. The method as claimed in claim 9, wherein in a case where it is detected that the quality of the link communication is greater than the preset threshold, the method further comprises:
sending a second control message to the second device;
wherein the second control message is configured to instruct the second device to adjust its own modulation mode to the third modulation mode.

11. A Bluetooth communication method, performed by a second device, a Bluetooth connection being established between the second device and a first device, wherein the method comprises:
performing, according to a first modulation mode, link communication with the first device; and
receiving a first control message sent by the first device, adjusting a modulation mode of the second device from the first modulation mode to a second modulation mode, the second modulation mode being indicated by the first control message, and performing the link communication with the first device according to the second modulation mode;
wherein the second modulation mode is a modulation mode determined by the first device in a case where it is detected that quality of the link communication is less than a preset threshold, and an anti-interference capability of the second modulation mode is greater than that of the first modulation mode.

12. The method as claimed in claim 11, wherein the first modulation mode is an 8DPSK modulation mode; and
wherein the second modulation mode is a π/4-DQPSK modulation mode.

13. The method as claimed in claim 11, wherein after performing the link communication with the first device according to the second modulation mode, the method further comprises:
receiving a second control message sent by the first device, adjusting the modulation mode of the second device from the second modulation mode to a third modulation mode, the third modulation mode being indicated by the second control message, and performing the link communication with the first device according to the third modulation mode;
wherein the third modulation mode is a modulation mode determined by the first device in a case where it is detected that the quality of the link communication is greater than the preset threshold, and the anti-interference capability of the third modulation mode is less than that of the second modulation mode.

14. An electronic device, comprising:
a processor and a memory;
wherein the memory is configured to store a computer program, which when executed by the processor, causes the processor to perform a Bluetooth communication method, wherein a Bluetooth connection is established between the electronic device and a second device, the method comprising:
performing, according to a first modulation mode, link communication with the second device; and
in a case where it is detected that a quality of the link communication is less than a preset threshold, adjusting a modulation mode of the electronic device from the first modulation mode to a second modulation mode, and performing the link communication with the second device according to the second modulation mode;
wherein an anti-interference capability of the second modulation mode is greater than that of the first modulation mode.

15. The electronic device as claimed in claim 14, wherein in a case where it is detected that the quality of the link communication is less than the preset threshold, the method further comprises:
sending a first control message to the second device;
wherein the first control message is configured to instruct the second device to adjust its own modulation mode to the second modulation mode.

16. The electronic device as claimed in claim 14, wherein the detecting that the quality of the link communication is less than the preset threshold comprises:
determining a number of consecutive retransmissions of data sent by the first device; and
in a case where the number of consecutive retransmissions is greater than a first threshold, determining that the quality of the link communication is less than the preset threshold.

17. The electronic device as claimed in claim 14, wherein the detecting that the quality of the link communication is less than the preset threshold comprises:
determining a packet error rate of data sent by the first device; and
in a case where the packet error rate is greater than a second threshold, determining that the quality of the link communication is less than the preset threshold.

18. The electronic device as claimed in claim 14, wherein the detecting that the quality of the link communication is less than the preset threshold comprises:
determining a received signal strength indicator message for data received by the first device; and
in a case where the received signal strength indicator message is less than a third threshold, determining that the quality of the link communication is less than the preset threshold.

19. The electronic device as claimed in claim 14, wherein modulation modes supported by the Bluetooth connection comprise: GFSK modulation mode, π/4-DQPSK modulation mode, and 8DPSK modulation mode;
wherein the anti-interference capability of the 8DPSK modulation mode is less than that of the GFSK modulation mode, and the anti-interference capability of the GFSK modulation mode is less than that of the π/4-DQPSK modulation mode.

20. The electronic device as claimed in claim 19, wherein the first modulation mode is the 8DPSK modulation mode; and
wherein the second modulation mode is the π/4-DQPSK modulation mode.
